(19) United States
(12) Patent Application Publication
(10) Pub. No.: US 2012/0233377 A1
(43) Pub. Date: Sep. 13, 2012

(54) Cache System and Processing Apparatus

(76) Inventors: Kumiko NOMURA, Tokyo (JP); Keiko Abe, Kanagawa-ken (JP); Shinobu Fujita, Tokyo (JP)

(21) Appl. No.: 13/234,221

(22) Filed: Sep. 16, 2011

(30) Foreign Application Priority Data
Mar. 11, 2011 (JP) 2011-054757

(51) Int. Cl. G06F 12/08

(52) U.S. Cl. 711/3; 711/E12.017

(57) ABSTRACT

According to an embodiment, a cache system includes a volatile cache memory, a nonvolatile cache memory, an address decoder, and an evacuation unit. The nonvolatile cache memory has a capacity equal to the volatile cache memory. The address decoder designates a same line to the volatile cache memory and the nonvolatile cache memory. The evacuation unit stores data which is inputted from the volatile cache memory and outputs the stored data to the volatile cache memory.

### CROSS REFERENCE TO RELATED APPLICATION

This application is based upon and claims the benefit of priority from the prior Japanese Patent Application No. P2011-054757, filed on Mar. 11, 2011, the entire contents of which are incorporated herein by reference.

### FIELD

Embodiments described herein relate to a cache system and a processing apparatus.

### BACKGROUND

Recently, an entire circuit system has been required to achieve lower power consumption. A processor portion in such circuit system in particular is often not used even during the operation of the circuit system. Accordingly, reduction in the power consumption of the processor portion leads to reduction in the power consumption of the entire circuit system. Therefore, a method has been employed in which the power consumption of the processor portion is reduced by lowering an operation frequency when the processor is not used. However, with the method, operating power cannot be turned off even while the processor is in stand-by. Thus, further reduction in the power consumption is needed. Against the background, it is conceivable to configure a cache included in the processor with a nonvolatile memory and to disconnect the operating power to the processor portion while the processor is in stand-by. However, the performance of the processor is deteriorated because a write speed of a nonvolatile memory is slower than that of a volatile memory.

### BRIEF DESCRIPTION OF THE DRAWINGS

FIG. 1 is a block diagram showing the configuration of an information processing apparatus according to an embodiment;

FIG. 2 is a block diagram showing the configuration of a cache of an information processing apparatus according to an embodiment;

FIG. 3 is a flowchart showing an operation of the cache in the information processing apparatus according to an embodiment in a third operation mode;

FIG. 4 is a flowchart showing an operation of the cache in the information processing apparatus according to an embodiment in the third operation mode;

FIG. 5 is a block diagram showing the configuration of a modification of the cache of the information processing apparatus according to an embodiment; and

FIG. 6 is a flowchart showing an operation of a modification of the cache in the information processing apparatus according to an embodiment in the second operation mode.

### DETAILED DESCRIPTION

According to an embodiment, a cache system includes a volatile cache memory, a nonvolatile cache memory, an address decoder, and an evacuation unit. The nonvolatile cache memory has a capacity equal to the volatile cache memory. The address decoder designates a same line to the volatile cache memory and the nonvolatile cache memory. The evacuation unit stores data which is inputted from the volatile cache memory and outputs the stored data to the volatile cache memory.

In the following description, several embodiments will be further described by referring to the drawings. In the drawings, same reference numerals are given to denote same or similar portions.

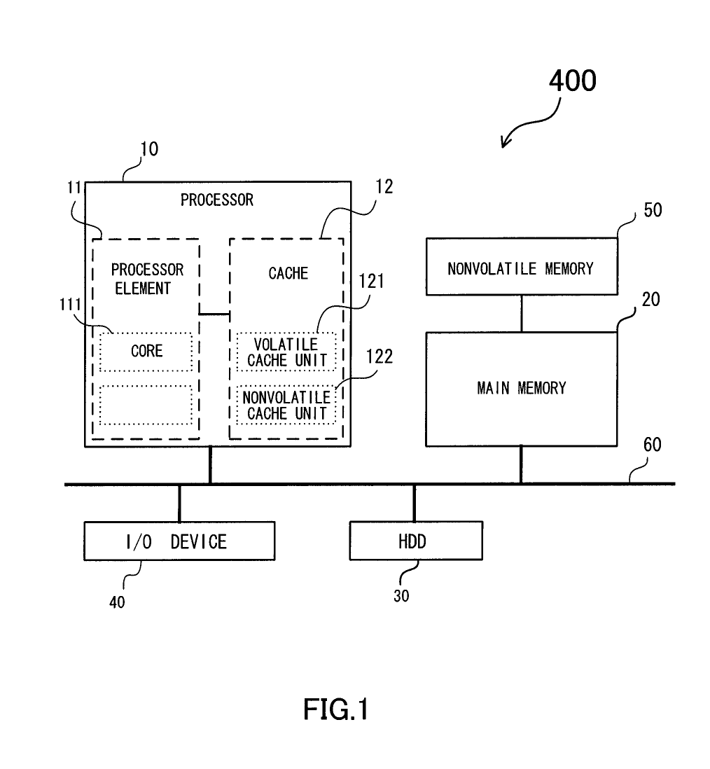

A cache system and a processing unit according to an embodiment are described by referring to the drawings. FIG. 1 is a configuration diagram of an information processing apparatus according to the embodiment. The information processing apparatus 400 may be a communication device, a PC, or a television, for example, in which a processor 10, a main memory 20, a hard disk 30, and an input/output device 40 are connected to each other through a bus 60. A nonvolatile memory 50 is connected to the main memory 20.

The processor 10 as a processing apparatus includes a processor element (PE) 11 and a cache 12. The processor element 11 includes a core 111 which performs an operation, a high-speed storage device called as an L1 cache, and the like. The processor 10 according to the embodiment reduces power consumption of the processor 10 by repeatedly turning on and off the power of the processor depending on the operating state of the processor 10.

The cache 12 as a cache system includes a volatile cache unit 121 having a volatile memory and a nonvolatile cache unit 122 having a nonvolatile memory. The volatile memory may be an SRAM (Static Random Access Memory) or the like, for example. The nonvolatile memory may be an MRAM (Magnetoresistive Random Access Memory), an FeRAM (Ferroelectric Random Access Memory), an ReRAM (Resistance Random Access Memory), a PRAM (Phase change RAM), or the like, for example. When the MRAM is used as the nonvolatile memory, as compared with the case where other nonvolatile memories are used, a resistance to rewrite is high and a write speed is fast. Also, when the FeRAM is used as the nonvolatile memory, the FeRAM has a substantially same level of resistance to rewrite as that of the MRAM and has a good compatibility with the well-known process of making an integrated circuit. Thus, the FeRAM is readily manufactured.

In the case that it is assumed that the cache 12 is configured only by the volatile memory, when the power of the processor 10 is turned off, all pieces of the data saved in the cache 12 are erased. Accordingly, it is needed to read the data from an upper storage medium (such as the main memory 20 or the hard disk 30) when the processor 10 restarts an operation. As a result, the processing time is deteriorated. Moreover, in the case that it is assumed that the cache 12 is configured only by the nonvolatile memory, the performance of the processor 10 is deteriorated because a write speed of the nonvolatile memory is slow as compared with that of the volatile memory.

On the other hand, the cache 12 uses a hybrid cache structure in which the volatile cache unit 121 and the nonvolatile cache unit 122 are combined. When the power of the processor 10 is temporarily turned off, the cache 12 evacuates the data stored in the volatile cache unit 121 to the nonvolatile cache unit 122 so as to prevent the data from being lost. Just after the power of the processor is turned on again, the cache 12 operates using the data saved in the nonvolatile cache unit 122.

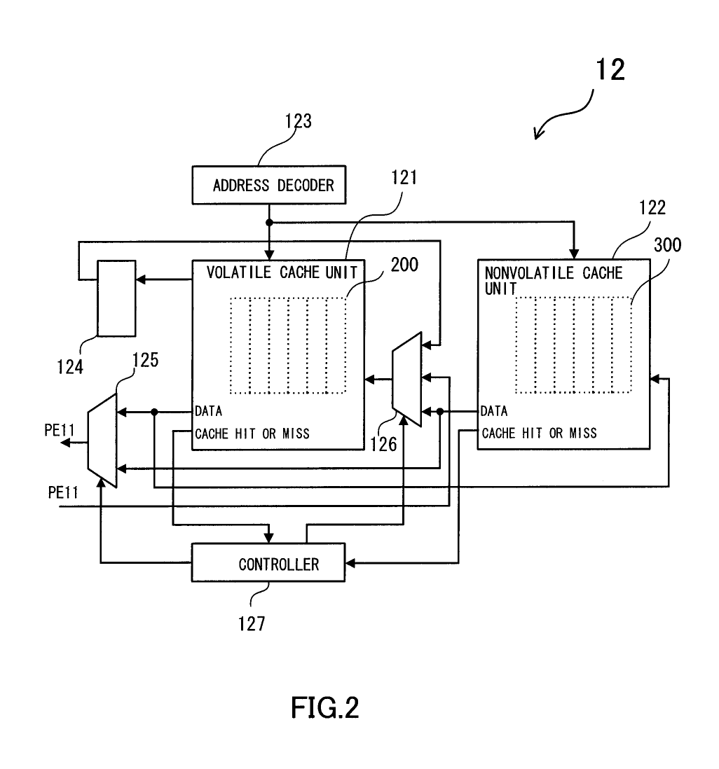

FIG. 2 is a block diagram showing the configuration of the cache 12. The cache 12 has the volatile cache unit 121, the nonvolatile cache unit 122, the address decoder 123, the evacuation unit 124, a multiplexer 125, a multiplexer 126, and a controller 127. The volatile cache unit 121 includes a volatile memory 200 which is a volatile cache memory. The nonvolatile cache unit 122 includes a nonvolatile cache memory 300 which is a nonvolatile cache memory.

The volatile memory 200 in the volatile cache unit 121 can store whether target data of a write request to the cache 12 from the processor element 11 or any piece of data fetched from the main memory 20, data stored in the nonvolatile memory 300 in the nonvolatile cache unit 122, or data stored in the evacuation unit 124. The target data of the write request from the processor element 11 is data which is used for the operation processing in the processor element 11 among the data included in the main memory 20 or the data included in the L1 cache in the processor element 11, for example.

The nonvolatile memory 300 in the nonvolatile cache unit 122 has a capacity equal to the volatile memory 200 in the volatile cache unit 121. The nonvolatile cache unit 122 can store the data stored in the volatile memory 200 in the volatile cache unit 121 in the nonvolatile memory 300.

The address decoder 123 designates a line to the volatile memory 200 in the volatile cache unit 121 and the nonvolatile memory 300 in the nonvolatile cache unit 122 in accordance with the address data which is outputted from the processor element 11. The address decoder 123 which is used to designate the line is shared by the volatile cache unit 121 and the nonvolatile cache unit 122, so that an area of the cache 12 can be reduced. However, since the address decoder 123 is shared, when the data stored in one of the volatile memory 200 in the volatile cache unit 121 and the nonvolatile memory 300 in the nonvolatile cache unit 122 is copied to the other one, the data is copied in the same line.

The evacuation unit 124 is connected to the volatile cache unit 121. The evacuation unit 124 is to temporarily store data and includes a memory such as a flip-flop (FF) or an SRAM, and can save the data for one line of the volatile memory 200 in the volatile cache unit 121.

Since the address decoder 123 is shared, when the data stored in the nonvolatile memory 300 in the nonvolatile cache unit 122 is copied to the volatile memory 200 in the volatile cache unit 121, the data is copied in the same line. Thus, when another piece of data is already stored in a write target line, the already-stored data is overwritten. When the overwritten data is one that has been used recently, the probability that the data is requested again is high. For this reason, the overwriting of the data may likely cause a cache miss. To avoid this situation, the evacuation unit 124 is used. When the data stored in the nonvolatile memory 300 in the nonvolatile cache unit 122 is copied to the volatile memory 200 in the volatile cache unit 122, in the case that data is already stored in the line which is designated by the address decoder 123, the data is temporarily evacuated to the evacuation unit 124. Then, after the copy of the data stored in the nonvolatile memory 300 in the nonvolatile cache unit 122 to the volatile memory 200 in the volatile cache unit 121 is completed, the address decoder 123 designates another line of the volatile memory 200 in the volatile cache unit 121 so as to save the data stored in the evacuation unit 124 in the designated line. Accordingly, overwriting which causes a higher probability of cache miss can be reduced.

The multiplexer 125 outputs any one of the data which is outputted from the volatile cache unit 121 and the data which is outputted from the nonvolatile cache unit 122 to the processor element 11 in accordance with the control of the controller 127.

The multiplexer 126 inputs any piece of the target data of a write request to the cache 12 from the processor element 11, the data stored in the main memory 20 or HDD 30, the data stored in the nonvolatile memory 300 in the nonvolatile cache unit 122, and the data stored in the evaluation unit 124 to the volatile cache unit 121 in accordance with the control of the controller.

The controller 127 controls the volatile cache unit 121, the nonvolatile cache unit 122, and the address decoder 123. Also, the controller 127 controls outputs of the multiplexer 125 and the multiplexer 126 in accordance with an address hit state acquired from the volatile cache unit 121 and the nonvolatile cache unit 122, and the type of request which is outputted from the processor element 11.

The operation of the cache 12 having the configuration as described above is described. The cache 12 includes the following three operation modes. A first operation mode only uses the volatile cache unit 121 as a cache. In other words, in the first operation mode, the cache 12 outputs data from the volatile cache unit 121 and stores data in the volatile cache unit 121 based on a request of the processor element 11. The data to be stored in the volatile cache is included in the main memory 20 or the data included in the L1 cache in the processor element 11

A second operation mode is used when the power of the processor 10 is turned off to perform power gating. At this time, the address decoder 123 designates a line for each of the memories in the volatile cache unit 121 and the nonvolatile cache unit 122, and the data in the volatile memory 200 is written line by line in the same line of the nonvolatile memory 300. Then, upon finishing the copying operation, the power of the cache 12 is turned off.

A third operation mode is used just after the processor 10 has returned from the power gating state until the operation mode is shifted to the first operation mode. Since the power of the cache 12 is turned off in the second operation mode, the data stored in the volatile cache unit 121 is erased. After that, when the processor 10 returns from the power gating state, the powers of both the volatile cache unit 121 and the nonvolatile cache unit 122 are turned on. At this time, the nonvolatile cache unit 122 stores data which is copied from the volatile cache unit 121 before the power gating, but the volatile cache unit 121 does not store the data.

For this reason, just after the processor 10 has returned from the power gating state, the data which is needed for the processor element 11 to perform processing is read from the nonvolatile cache unit 122 or the main memory 20. Then, the read data is stored in the volatile cache unit 121. Here, the data is written to the volatile cache unit 121 whose write speed is faster than that of the nonvolatile cache unit 122, so that the operating performance of the processor can be prevented from being deteriorated. However, the data which is stored in the volatile cache unit 121 is not limited to data which is referred from the nonvolatile cache unit 122. This means that the data which is stored in the same lines of the volatile cache unit 121 and the nonvolatile cache unit 122 is not necessarily same data.

Accordingly, when a certain period of time passes after the return from the power gating, there may be a case where, when the data in the nonvolatile cache unit 122 is stored in the volatile memory 200 in the volatile cache unit 121, data has been already stored in the line of the volatile cache unit 121 which is designated by the address decoder 123. For this reason, the data in the line of the volatile cache unit 121 is temporally evacuated to the evacuation unit 124 and, then, the data is copied from the nonvolatile cache unit 122 to the volatile cache unit 121. Thereafter, the evacuated data is stored in another line of the volatile memory 200 in the volatile cache unit 121. With this operation, the data which is recently stored in the volatile cache unit 121 can be prevented from being overwritten.

After that, when time further elapses, the volatile memory 200 in the volatile cache unit 121 runs short of free space. Therefore, the power of the nonvolatile cache unit 122 is turned off and the operation mode is shifted to the first operation mode, and the cache 12 uses the volatile cache unit 121 as a cache.

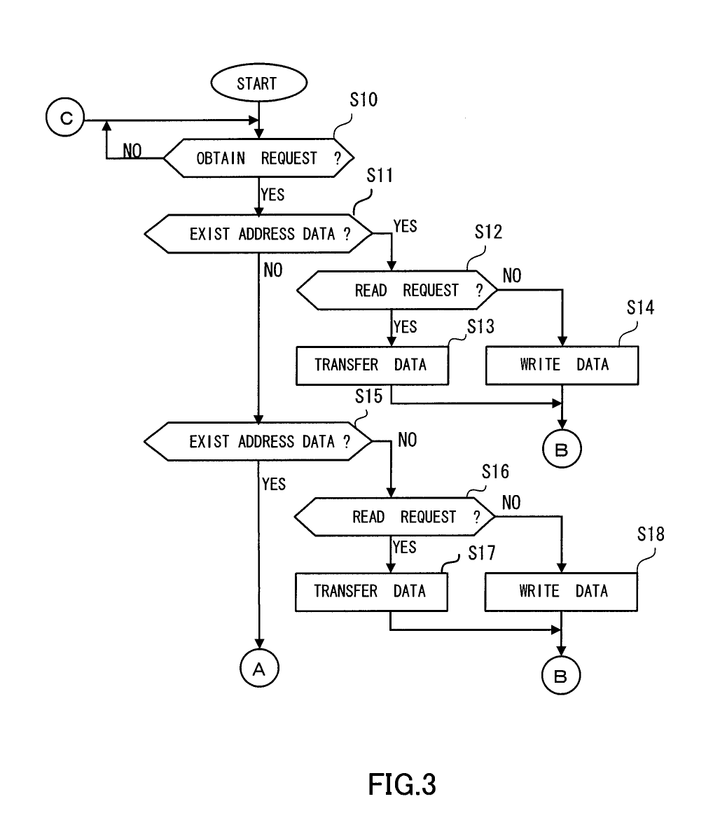

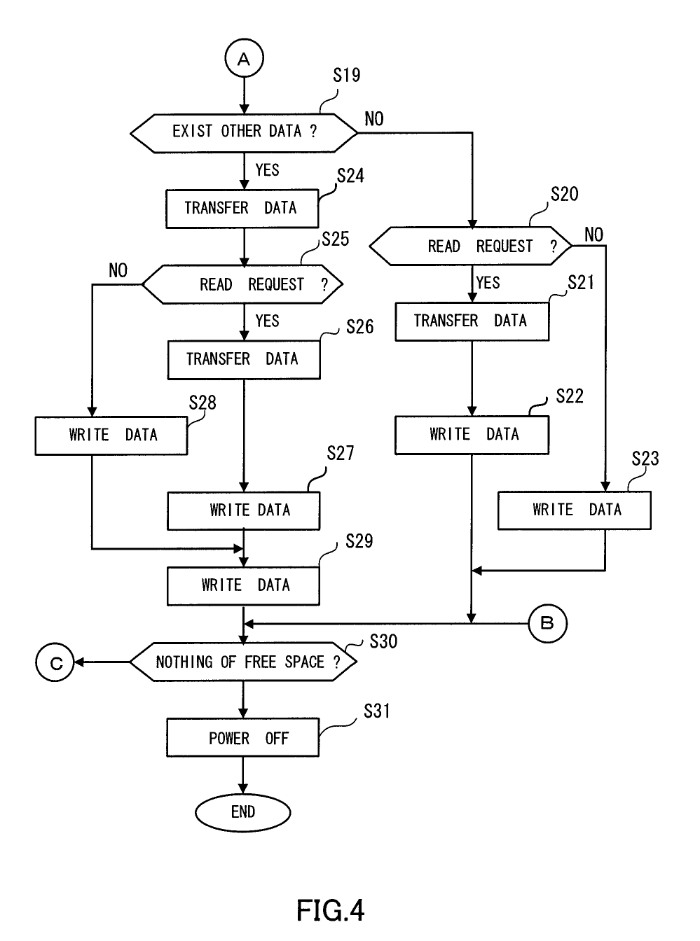

FIGS. 3 and 4 are flowcharts showing the operation of the cache in the third operation mode. When the processor 10 returns from the power gating state and the cache 12 acquires a request from the processor element 11 (YES at S10), it is checked whether data having a designated address exists in the volatile memory 200 in the volatile cache unit 121 (S11). When the data having the designated address exists in the volatile memory 200 in the volatile cache unit 121 (YES at S11) and the request from the processor element 11 is a read request (YES at S12), the data in the volatile cache unit 121 is transferred to the processor element 11 (S13). Also, when the data having the designated address exists in the volatile memory 200 in the volatile cache unit 121 (YES at S11) and the request from the processor element 11 is a write request (NO at S12), the data is written in a portion where the data having the designated address of the volatile memory 200 in the volatile cache unit 121 is written (S14).

On the other hand, the cache 12 also checks whether the data having the designated address exists in the nonvolatile memory 300 in the nonvolatile cache unit 122 based on the request acquired from the processor element 11 (S15). Here, the nonvolatile cache unit 121 and the volatile cache unit 122 may be checked in parallel. When the data having the designated address exists neither in the volatile memory 200 in the volatile cache unit 121 nor the nonvolatile memory 300 in the nonvolatile cache unit 122 (NO at S15), and the request from the processor element 11 is a read request (YES at S16), a read request is outputted to an upper storage medium (for example, the main memory 20), and the acquired data is written to the volatile memory 200 in the volatile cache unit 121 and is also sent to the processor element 11 (S17). When the data having the designated address exists neither in the volatile memory 200 in the volatile cache unit 121 nor the nonvolatile memory 300 in the nonvolatile cache unit 122 (NO at S15), and the request from the processor element 11 is a write request (NO at S16), the data is stored in the volatile memory 200 in the volatile cache unit 121 (S18). Note that, in the case that there is no space in the volatile memory 200 in the volatile cache unit 121 when the data is written, space is created by removing data in one of the lines to write the data in the created space. In the case that the data removed from the volatile memory 200 in the volatile cache unit 121 is needed, a write request is sent to the main memory 20, and the data is written in the main memory 20. For example, a method such as LRU (Least Recently Used) or the like is used to select a target line of the data to be removed.

When the data having the address designated by the processor element 11 does not exist in the volatile memory 200 in the volatile cache unit 121 and exists in the nonvolatile memory 300 in the nonvolatile cache unit 122 (YES at S15), the address decoder 123 designates a line of the nonvolatile cache unit 122 in which the data is stored. At the same time, the same line of the volatile cache unit 121 is also designated. After that, it is checked whether another piece of data is already stored in the line of the volatile memory 200 in the volatile cache unit 121 (S19).

At step S19, when the data is not stored in the line of the volatile memory 200 in the volatile cache unit 121 which is designated by the address decoder 123 (NO at S19), and the request from the processor element 11 is a read request (YES at S20), the data in the line of the nonvolatile memory 300 in the nonvolatile cache unit 122 is transferred to the processor element 11 (S21) and the data stored in the line of the nonvolatile memory 300 in the nonvolatile cache unit 122 which is designated by the address decoder 123 is written in the same line of the volatile memory 200 in the volatile cache unit 121 (S22). When the request from the processor element 11 is a write request (NO at S20), the data is not transferred to the processor element 11 and the data instructed by the processor element 11 is written in the line of the volatile memory 200 designated by the address decoder 123 (S23).

On the other hand, at step S19, in the case that the data is already stored in the line of the volatile memory 200 in the volatile cache unit 121 which is designated by the address decoder 123 (YES at S19), when the data in the designated line of the nonvolatile cache unit 122 is copied to the volatile memory 200 in the volatile cache unit 121, the data stored in the line is overwritten and thus the already-existing data has to be temporarily evacuated.

For this reason, the data stored in the line of the volatile memory 200 in the volatile cache unit 121 which is designated by the address decoder 123 is transferred to the evacuation unit 124 (S24).

Then, when the request from the processor element 11 is a read request (YES at S25), the data in the nonvolatile cache unit 122 which is designated by the address decoder 123 is transferred to the processor element 11 (S26). Thereafter, the data in the designated line of the nonvolatile cache unit 122 is written in the same line of the volatile cache unit 121 (S27). When the request from the processor element 11 is not a read request (NO at step S25), the data instructed by the processor element 11 is written in the line of the volatile cache unit which is designated by the address decoder 123 (S28). Thereafter, the line which is designated by the address decoder 123 is changed to free space in the volatile cache unit 121, for example, and then the data stored in the evacuation unit 124 is written in the volatile cache unit 121 (S29).

With the above-described procedures at step S24 to S29, the data stored in the volatile memory 200 in the volatile cache unit 121 can be prevented from being overwritten. Thus, the hit rate of the volatile cache unit 121 can be prevented from being decreased.

After each of the steps S13, S14, S17, S18, S22, S23, and S29 in FIGS. 3 and 4 is finished, it is checked whether there is free space in the volatile memory 200 in the volatile cache unit 121 (S30). In such a case that the volatile memory 200 in the volatile cache unit 121 has run short of free space because data is written in the volatile cache unit 121 at steps S14, S17, S18, S22, S23, and S29 (YES at S30), the power of the nonvolatile cache unit 122 is turned off (S31). Thereafter, the cache 12 is operated in the first operation mode.

Note that, although in the flowchart of FIG. 4, the description is given of the case where the operation mode is shifted to the first operation mode when the volatile memory 200 in the volatile cache unit 121 has run short of free space, the timing of shifting the operation mode to the first operation mode is not limited to this timing. For example, a timer is further provided in the processor 10 to shift the operation mode to the first operation mode when an elapsed time after the power gating exceeds a predetermined period of time.

With the embodiment as described above, the area can be reduced by sharing the address decoder, and when the processor 10 is in operation, data can be written to the volatile memory whose write speed is faster than that of the nonvolatile memory, so that an operation speed of only using the volatile memory, which is the same as that of the processor, can be maintained. In addition, although the data in the volatile memory 200 is erased when the power of the processor 10 including the volatile memory 200 is turned off, the data in the volatile memory 200 is stored in the nonvolatile memory 300 before the power of the volatile memory 200 is turned off. Thus, the data can be read from the nonvolatile memory 300 when the power of the processor 10 is turned on. Accordingly, an operation processing time can be prevented from being deteriorated.

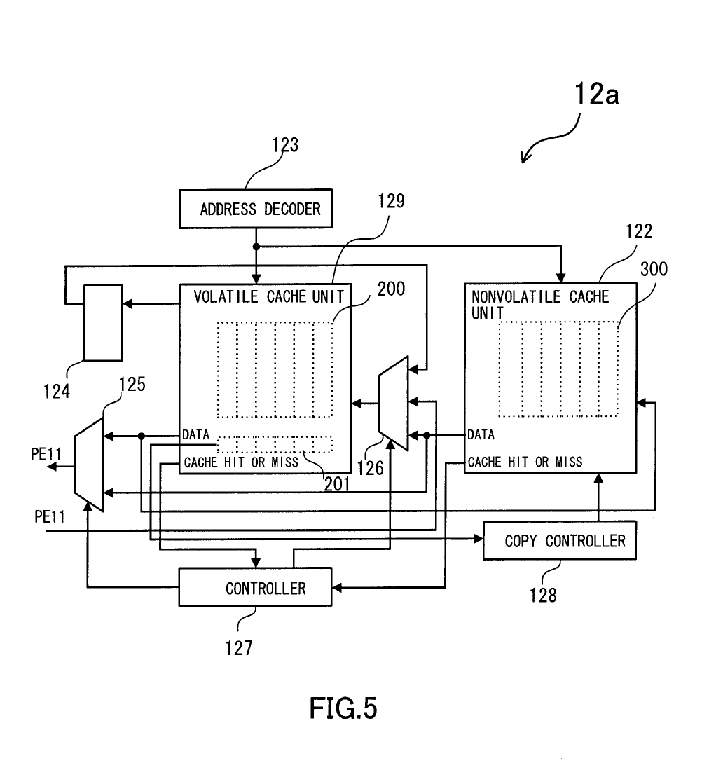

FIG. 5 is a block diagram showing a modification of the cache of the information processing apparatus according to the embodiment. In FIG. 5, same reference numerals are given to denote components identical to those of the cache 12 shown in FIG. 2 and the detailed description is omitted.

A volatile cache unit 129 of a cache 12a shown in FIG. 5 has a volatile memory 200 having the same capacity as of a nonvolatile memory 300 in a nonvolatile cache unit 122, and a memory 201 to store a flag showing whether data stored in each line of the volatile memory 200 in the volatile cache unit 129 is data copied from the nonvolatile cache unit 122. The flag stored in the memory 201 is set when the data is copied from the nonvolatile cache unit 122 to the volatile cache unit 129 (for example, when data is stored at steps S22 and S26 in FIG. 4). Then, the memory 201 is configured of a volatile memory, so that the set flag can be reset when power of the processor 10 is turned off.

In addition, the cache 12a has a copy controller 128. The copy controller 128 receives the flag showing whether the data stored in each line is data copied from the nonvolatile cache unit 122 from the memory 201 in the volatile cache unit 129, and controls whether the data in the volatile memory in the volatile cache unit 129 is copied for each line of the nonvolatile memory in the nonvolatile cache unit 122 during the power gating.

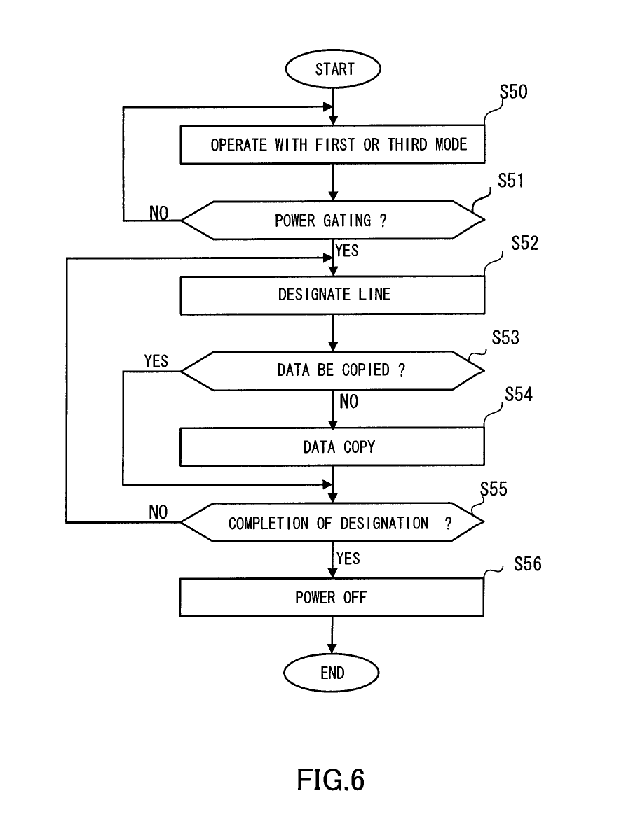

FIG. 6 is a flowchart showing an operation of the cache 12a in the second operating mode. When the processor element 11 determines based on the operating state of the processor 10 that power of the processor 10 is temporarily turned off (YES at S51) to perform power gating during performing the operation in the first operation mode or the third operation mode (S50), the address decoder 123 designates one of the address lines of the memories in the volatile cache unit 129 and the nonvolatile cache unit 122 (S52). Then, the copy controller 128 checks the memory 201 in the volatile cache unit 129, and checks whether the data stored in the line of the volatile memory 200 in the volatile cache unit 129, which is designated by the address decoder 123, is copied from the nonvolatile cache unit 122 (S53).

When the data stored in the volatile memory 200 in the volatile cache unit 129 is data copied from the nonvolatile cache unit 122 (YES at S53), the data stored in the line of the volatile memory 200 in the volatile cache unit 129 and the data stored in the line of the nonvolatile memory 300 in the nonvolatile cache unit 122 are same data. Thus, with regard to the data in the line, there is no need to copy data from the volatile memory 200 in the volatile cache unit 129 to the nonvolatile memory 300 in the nonvolatile cache unit 122.

On the other hand, in the case that the data stored in the volatile memory 200 in the volatile cache unit 129 is data copied from the main memory 20 (for example, in the case of data stored at steps S17 and S18 in FIG. 3), for example, the data is not stored in the nonvolatile memory 300 in the nonvolatile cache unit 122. Accordingly, the data stored in the line of the volatile memory 200 in the volatile cache unit 129 is copied to the same line of the nonvolatile memory 300 in the nonvolatile cache unit 122 (S54).

The processes at steps S52 to S54 are repeated, and when the address decoder 123 finishes designation of all the lines of the volatile memory 200 in the volatile cache unit 129 and the nonvolatile memory 300 in the nonvolatile cache unit 122 (YES at S55), the power of the cache 12a is turned off (S56) to finish the second operation mode.

According to the modification, when the data stored in the lines of the memory in the volatile cache unit 129 and the data stored in the memory in the nonvolatile cache unit 122 are same, the data is not copied from the volatile cache unit 129 to the nonvolatile cache unit 122. Thus, the power can be turned off more quickly.

Note that, when the cache 12 is mapped by using the n-way set associative method, the same data is stored only in the same way on the same line of the volatile cache unit 129 and the nonvolatile cache unit 122. In this case, the evacuation unit 124 stores the data for one way of the volatile cache unit 129. Also, flags for the number of ways (N-ways) are stored for one line of the volatile memory 200 in the volatile cache unit 129. With the N-flags, only the data copied from the nonvolatile memory 300 in the nonvolatile cache unit 122 can be specified among the N-pieces of data stored in the line of the volatile memory 200 in the volatile cache unit 129. Then, the data which is confirmed by the flag that the data is copied from the nonvolatile cache unit 122 (for example, referred to as data A) is not copied from the volatile cache unit 129 to the nonvolatile cache unit 122, and the data which is not copied from the nonvolatile cache unit 122 is only needed to be stored in a line other than the line of the nonvolatile cache unit 122 in which the data A is stored.

While certain embodiments have been described, these embodiments have been presented by way of example only, and are not intend to limit the scope of the inventions. Indeed, the novel embodiments described herein may be embodied in a variety of the other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A cache system, comprising:
a volatile cache memory;
a nonvolatile cache memory having a capacity equal to a capacity of the volatile cache memory;
an address decoder to designate the same line to the volatile cache memory and the nonvolatile cache memory; and
an evacuation unit to store data to be inputted from the volatile cache memory, the evacuation unit to output the stored data inputted from the volatile cache memory to the volatile cache memory.

2. The cache system according to claim 1, further comprising a controller to perform control to read a first data stored in a first line of the nonvolatile cache memory and to store the first data in the first line of the volatile cache memory, when the controller receives a request for the first data stored in the nonvolatile cache memory.

3. The cache system according to claim 2, wherein, in the case that the first data stored in the nonvolatile cache memory is to be stored in the volatile cache memory, when a second data has been stored in the first line of the volatile cache memory, the controller causes the second data stored in the volatile cache memory to be stored in the evacuation unit, and then, the controller causes the first data stored in the nonvolatile cache memory to be stored in the volatile cache memory, and thereafter, the controller causes the second data stored in the evacuation unit to be stored in the volatile cache memory.

4. The cache system according to claim 3, wherein, the power of the volatile cache memory and nonvolatile cache memory are turned off after the controller caused the data stored in the volatile cache memory to be stored in the nonvolatile cache memory.

5. The cache system according to claim 4, further comprising a memory to store a flag for each line of the volatile cache memory, the flag showing whether the data stored in the line of the volatile cache memory is data copied from the data in the nonvolatile cache memory, wherein,
when the controller causes the data stored in the volatile cache memory to be stored in the nonvolatile cache memory, the controller copies data stored in a line of the volatile cache memory in the nonvolatile cache memory, the line being associated with the flag showing that the data is not data copied from the data in the nonvolatile cache memory in the memory.

6. The cache system according to claim 4, further comprising a memory to store a flag for each way for each line of the volatile cache memory, the flag showing whether the data stored in the way of the volatile cache memory is data copied from the data in the nonvolatile cache memory, wherein,
When the controller causes the data stored in the volatile cache memory to be stored in the nonvolatile cache memory, the controller copies, in the nonvolatile cache memory, data stored in the way of the line of the volatile cache memory, whose flag stored in the memory shows that the data in the way is not data copied from the data in the nonvolatile cache memory.

7. The cache system according to claim 2, wherein the controller turns off power of the nonvolatile cache memory when the volatile cache memory has no free space.

8. The cache system according to claim 1, wherein the nonvolatile cache memory is a magnetoresistive memory or a ferroelectric memory.

9. A processing apparatus, comprising a cache system and a processor element, wherein the cache system includes:
a volatile cache memory;
a nonvolatile cache memory having a capacity equal to a capacity of the volatile cache memory;
an address decoder to designate the same line to the volatile cache memory and the nonvolatile cache memory; and
an evacuation unit to store data to be inputted from the volatile cache memory and output the stored data to the volatile cache memory,
wherein the processor element performs operation using data inputted from the volatile cache memory to be outputted from the cache system.

10. The processing apparatus according to claim 9, further comprising a controller to perform control to read a first data stored in a first line of the nonvolatile cache memory and to store the first data in the first line of the volatile cache memory, when the controller receives a request for the first data stored in the nonvolatile cache memory.

11. The processing apparatus according to claim 10, wherein, in the case that the first data stored in the nonvolatile cache memory is to be stored in the volatile cache memory, when a second data has been stored in the first line of the volatile cache memory, the line being designated by the address decoder, the controller causes the second data stored in the volatile cache memory to be stored in the evacuation unit, and then, the controller causes the first data stored in the nonvolatile cache memory to be stored in the volatile cache memory, and thereafter, the controller causes the second data stored in the evacuation unit to be stored in the volatile cache memory.

12. The processing apparatus according to claim 11, wherein, the controller turns off the power of the volatile cache memory after the controller caused the data stored in the volatile cache memory to be stored in the nonvolatile cache memory.

13. The processing apparatus according to claim 12, further comprising a memory to store a flag for each line of the volatile cache memory, the flag showing whether the data stored in the line of the volatile cache memory is data copied from the data in the nonvolatile cache memory, wherein,
When the controller causes the data stored in the volatile cache memory to be stored in the nonvolatile cache memory, the controller copies data stored in a line of the volatile cache memory in the nonvolatile cache memory, the line being associated with the flag showing that the data is not data copied from the data in the nonvolatile cache memory in the memory.

14. The processing apparatus according to claim 12, further comprising a memory to store a flag for each way for each line of the volatile cache memory, the flag showing whether the data stored in the way of the volatile cache memory is data copied from the data in the nonvolatile cache memory, wherein,
When the controller causes the data stored in the volatile cache memory to be stored in the nonvolatile cache memory, the controller copies, in the nonvolatile cache memory, data stored in the way of the line of the volatile cache memory, whose flag stored in the memory shows that the data in the way is not data copied from the data in the nonvolatile cache memory.

15. The processing apparatus according to claim 10, wherein the controller turns off power of the nonvolatile cache memory when the volatile cache memory has no free space.

16. The processing apparatus according to claim 9, wherein the nonvolatile cache memory is a magnetoresistive memory or a ferroelectric memory.
